(19) United States
(12) Patent Application Publication
(10) Pub. No.: US 2006/0265540 A1
(43) Pub. Date: Nov. 23, 2006

(54) Method and apparatus for isolating universal serial bus (USB) communications link

(75) Inventors: William R. Mass, Maple Grove, MN (US); Jay Axelrod, Minneapolis, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Cardiac Pacemakers, Inc.

(21) Appl. No.: 11/130,723

(22) Filed: May 17, 2005

(51) Int. Cl. G06F 13/14

(52) U.S. Cl. 710/305

(57) ABSTRACT

A structure and method for electrically isolating a universal serial bus (USB) communication link is provided. One aspect of this disclosure relates to a system for isolating a host from a peripheral. The system includes a first programmable logic device for selectively passing two host USB lines into four host unidirectional lines. Four optoisolators are connected to the first programmable device via the four host unidirectional lines. A second programmable logic device for selectively passing four peripheral unidirectional lines into two peripheral USB lines is connected to the four optoisolators via the four peripheral unidirectional lines. The first and second programmable logic devices detect arriving edge transitions to determine whether a signal is arriving from a host or a peripheral, and disable and enable corresponding input and output lines to maintain unidirectional flow of the signal through the four optoisolators. Other aspects and embodiments are provided herein.

### TECHNICAL FIELD

This disclosure relates to serial electronic communication using a universal serial bus (USB) link, particularly structures and methods for electrically isolating hosts and peripherals that communicate over a USB link.

### BACKGROUND

USB link has become a widely used standard for connecting peripheral devices to host devices in a number of applications, including personal computers and medical devices. USB allows a large number of peripheral devices to be connected to a host and does not require initialization. Additional advantages of USB link include decreased cost, increased compatibility, and a greater number of available peripherals. USB peripherals deliver on the promise of plug and play convenience by eliminating the need to turn off or restart the computer when attaching a new peripheral. USB connections require no terminators, memory addresses or ID numbers. They also use a cable that is small, simple, inexpensive and easy to attach. USB supports simultaneous connection of multiple devices by attaching peripherals through interconnected external hubs. In addition, USB offers data transfer rates much faster than traditional serial ports.

Often peripheral devices need both electrical isolation and a bidirectional communication link to a computer, phone, line, or other electrical device. One example is peripheral devices that interface, either directly or indirectly, with implantable medical devices (IMDs). Electrical isolation is necessary to prevent injury to a patient with an IMD from stray currents and potentials from electrically powered equipment that interfaces with the IMD during implantation and programming.

The convenience of USB links makes it desirable for connecting peripherals to host programmers in medical device applications. These links should provide convenient, reliable and inexpensive connections of medical devices without significant risk of injury to the patient from stray currents or potentials.

### SUMMARY

The above-mentioned problems and others not expressly discussed herein are addressed by the present subject matter and will be understood by reading and studying this specification.

Disclosed herein, among other things, is an apparatus for electrically isolating a universal serial bus (USB) communication link. The apparatus includes first logic including a first bidirectional universal serial bus (USB) connection, the first logic to receive a pair of incoming complementary USB signals from the first USB connection and produce a first output signal and a second output signal and for receiving a first input signal and a second input signal and produce a pair of outgoing complementary USB signals at the first USB connection. The apparatus also includes second logic including a second bidirectional universal serial bus (USB) connection, the second logic to receive a pair of incoming complementary USB signals from the second bidirectional USB connection and produce a third output signal and a fourth output signal and for receiving a third input signal and a fourth input signal and produce a pair of outgoing complementary USB signals at the second USB connection. The apparatus further includes a bank of four optoisolators to isolate the first logic from the second logic, such that the first output signal is optically isolated to produce the third input signal, the second output signal is optically isolated to produce the fourth input signal, the third output signal is optically isolated to produce the first input signal, and the fourth output signal is optically isolated to produce the second input signal. According to this embodiment, the first logic and the second logic detect arriving edge transitions to determine whether a signal is arriving from a host or a peripheral, and disable and enable corresponding input and output lines to maintain unidirectional flow of the signal through the bank of optoisolators.

One aspect of this disclosure relates to a method for electrically isolating a host and peripheral. According to one embodiment, the method includes receiving an input signal at a first programmable logic device over a first bidirectional communication line and detecting the rising edge of the input signal using the first programmable logic device to determine the direction of the input signal. According to various embodiments, the method also includes transmitting an output signal over a unidirectional output line in the direction of the input signal and passing the output signal through an electrical isolation barrier to create an isolated signal. According to various embodiments, the method further includes receiving the isolated signal at a second programmable logic device over a unidirectional input line, detecting the rising edge of the isolated signal using the second programmable logic device to determine the direction of the isolated signal, and transmitting the isolated signal from the second programmable logic device in the detected direction over a second bidirectional communication line.

One aspect of this disclosure relates to a method for constructing an isolation barrier between a USB host and a USB peripheral. According to various embodiments, the method includes providing a host programmable device for bidirectionally converting at least one host USB bidirectional line into a pair of host unidirectional lines. The method further includes providing a plurality of optoisolators connected to the host programmable device via the pair of host unidirectional lines. The method also includes providing a peripheral programmable device for bidirectionally converting at least one pair of peripheral unidirectional lines into a peripheral USB bidirectional line, the peripheral programmable device connected to the plurality of optoisolators via the peripheral unidirectional lines. According to various embodiments, the method further includes detecting arriving edge transitions, using the host programmable device and the peripheral programmable device, to determine when a signal is arriving from a host or a peripheral. According to various embodiments, the method also includes disabling and enabling corresponding input and output lines based on the detected arriving edge transitions, using the host programmable device and the peripheral programmable device, to maintain unidirectional flow of the signal through the plurality of optoisolators.

This Summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE DRAWINGS

FIG. 1 illustrates a block diagram of an apparatus for isolating a USB link, according to one embodiment.

FIG. 2 illustrates a circuit diagram of a system for isolating a USB link, according to one embodiment.

FIG. 3 illustrates a state machine for isolating a USB link, according to one embodiment.

FIG. 4 illustrates a perspective view of a circuit for isolating a USB link, according to one embodiment.

FIG. 5 illustrates a flow diagram of a method for constructing an isolation barrier between a USB host and a USB peripheral, according to one embodiment.

FIG. 6 illustrates a flow diagram of a method for electrically isolating a host and peripheral, according to one embodiment.

FIG. 7 illustrates a schematic diagram of portions of a cardiac rhythm management system with a pacing system analyzer and an environment in which they are used, according to one embodiment.

FIG. 8 illustrates a schematic diagram of portions of a cardiac rhythm management system and an environment in which it is used, according to one embodiment.

FIG. 9 illustrates a schematic diagram of a medical device programmer, according to one embodiment.

### DETAILED DESCRIPTION

The following detailed description refers to the accompanying drawings which show, by way of illustration, specific aspects and embodiments in which the present invention may be practiced. The various embodiments are not necessarily mutually exclusive, as aspects of one embodiment can be combined with aspects of another embodiment. These embodiments are described in sufficient detail to enable those skilled in the art to practice the invention. Other embodiments may be utilized and structural, logical, and electrical changes may be made without departing from the scope of the present invention.

A system and method of isolating a USB signal is realized through the use of programmable logic devices and high speed optoisolators. Two key considerations exist is isolating a USB signal: the bidirectional lines and signal speed. The relatively high transmission speeds of USB may preclude the use of bidirectional pulse transformers due to their relatively slow rise/fall times. According to the disclosed embodiments, the programmable logic devices (PLDs) serve to convert the bidirectional USB signal into receive and transmit components. The optoisolators provide the needed electrical isolation and transmission speed, which allows for complete signal and power isolation as required for medical patient isolation. According to various embodiments, the disclosed system and method could be used to electrically isolate any bidirectional communications link. Various embodiments disclosed relate to medical devices, specifically patient interface devices that communicate with implantable medical devices.

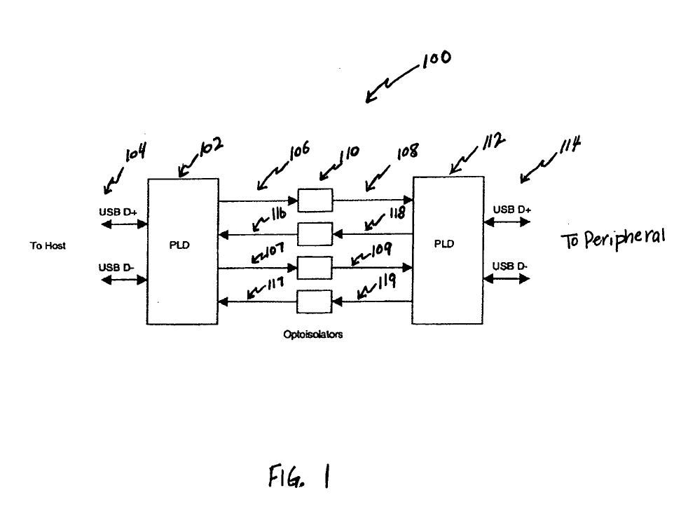

FIG. 1 illustrates a block diagram of an apparatus 100 for isolating a USB link, according to one embodiment. According to this embodiment, the apparatus includes first logic 102 including a first bidirectional universal serial bus (USB) connection, the first logic 102 to receive a pair of incoming complementary USB signals 104 from the first USB connection and produce a first output signal 106 and a second output signal 107 and for receiving a first input signal 116 and a second input signal 117 and produce a pair of outgoing complementary USB signals 104 at the first USB connection. The apparatus also includes second logic 112 including a second bidirectional universal serial bus (USB) connection, the second logic 112 to receive a pair of incoming complementary USB signals 114 from the second bidirectional USB connection and produce a third output signal 118 and a fourth output signal 119 and for receiving a third input signal 108 and a fourth input signal 109 and produce a pair of outgoing complementary USB signals 114 at the second USB connection. The apparatus further includes a bank of four optoisolators 110 to isolate the first logic 102 from the second logic 112, such that the first output signal 106 is optically isolated to produce the third input signal 108, the second output signal 107 is optically isolated to produce the fourth input signal 109, the third output signal 118 is optically isolated to produce the first input signal 116, and the fourth output signal 119 is optically isolated to produce the second input signal 117. According to this embodiment, the first logic 102 and the second logic 112 detect arriving edge transitions to determine whether a signal is arriving from a host or a peripheral, and disable and enable corresponding input and output lines to maintain unidirectional flow of the signal through the bank of optoisolators 110.

According to one embodiment, programmable logic devices (PLDs) are utilized for the first and second logic. Those skilled in the art will recognize that the same functionality can be implemented using other known or yet to be developed logic devices. According to various embodiments complex PLDs (CPLDs) are used in the system. According to further embodiments Field Programmable Logic Arrays (FPLAs) are used in the system. Other embodiments use microprocessors, microcontrollers, Field Programmable Gate Arrays (FPGAs) or discrete logic components for the first and second logic of FIG. 1.

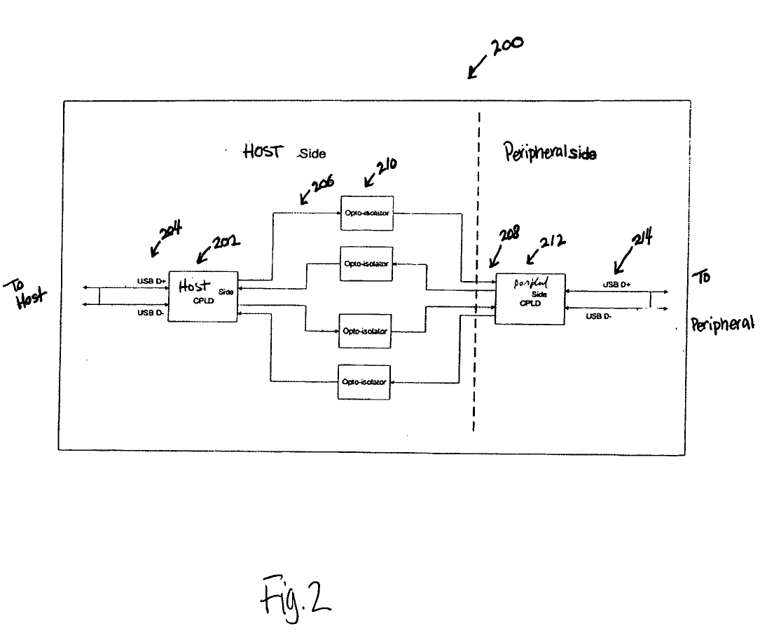

FIG. 2 illustrates a circuit diagram of a system 200 for isolating a USB link, according to one embodiment. The system includes a first programmable logic device 202 for selectively passing two host USB lines 204 into four host unidirectional lines 206. According to one embodiment, four optoisolators 210 are connected to the first programmable device 202 via the four host unidirectional lines 206. The present embodiment of the system includes a second programmable logic device 212 for selectively passing four peripheral unidirectional lines 208 into two peripheral USB lines 214, and the second programmable logic device 212 is connected to the four optoisolators 210 via the four peripheral unidirectional lines 208. In various embodiments, the first programmable logic device 202 and the second programmable logic device 212 detect arriving edge transitions to determine the direction of the signal, and enable outputs in the directional of the signal and disable outputs in the opposite direction of the signal to maintain unidirectional flow of the signal through the optoisolators 210.

The illustrated embodiment utilizes optoisolators 210 to electrically isolate the host from the peripheral. Optoisolators provide the necessary isolation while accommodating the speed necessary for full-speed USB by providing a minimal propagation delay. In one embodiment, Agilent® HCNW2611 optoisolators are used. Other types of optoisolators are used in further embodiments. In various embodiments, the electrical isolation is accomplished through the use of magnetic isolators instead of optoisolators. In various embodiments, the electrical isolation is accomplished through the use of laser isolators. In various embodiments, the electrical isolation is accomplished through the use of infrared devices, such as an Infrared Data Association (IrDA) bridge.

The illustrated embodiment depicts the optoisolators 210 residing on the host side of the system. One of skill in the art will appreciate that the isolators may be housed on the peripheral side, or separately from the host and the peripheral, and accomplish the same functionality.

The logic contained within the PLDs uses the steady state condition of USB data lines along with arriving edge transitions to determine when a signal is arriving from either the host or the peripheral (aka application). For example, if a signal arrives from the host, the PLD on the host side will send out the signal on the output lines and disable the incoming lines from the peripheral. The PLD on the peripheral side will see the signal transition on the incoming host lines and will relay the signal to the peripheral via the bidirectional USB lines. The PLDs monitor incoming signals from the USB lines as well as the incoming signals coming across the isolated interface. Using a “first come, first serve” system, the PLDs pass the incoming signal through to the appropriate output.

The use of optoisolators in conjunction with PLDs adds delay to the system, which must be minimized to permit normal USB communication. In addition, the reassembled signals at the receiving end must represent the original signal's pulse width as closely as possible. Therefore, in various embodiments, the disclosed PLDs use state machines triggered off of the rising and falling clock edges. The propagation delay is a function of the type of PLD and isolators used, and must be kept within the requirements of the USB specification. As previously discussed, embodiments using variations of PLDs and isolators are contemplated

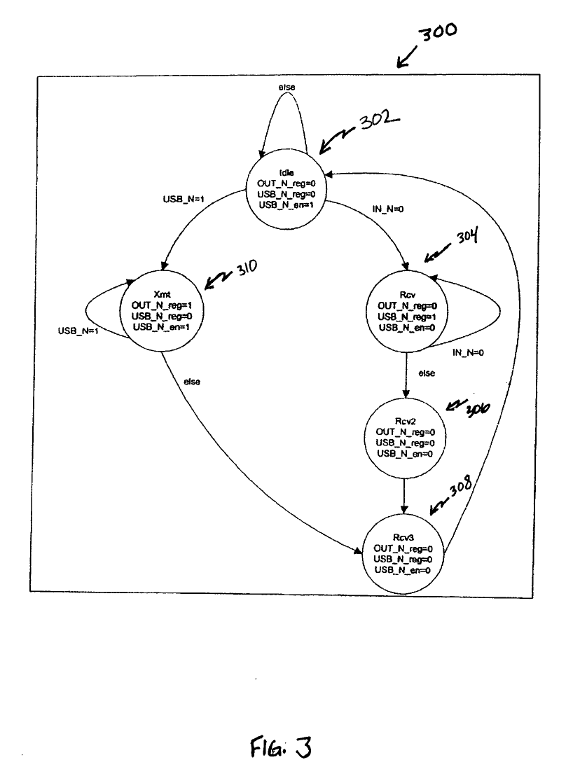

FIG. 3 illustrates a state machine 300 for isolating a USB link, according to one embodiment. As stated above, the programmable devices use the logic of the state machine to convert bi-directional lines to unidirectional lines, and unidirectional lines to bi-directional lines, and to ensure that signals propagate in only one direction at a given time by disabling unused inputs and outputs. The logic begins at initial state (or steady state or idle state) 302. If a leading edge of a signal is detected to transmit (USB_N=1), the state machine advances to transmit state 310 and sets register and enable values as illustrated. When USB_N no longer is at logic one, the state machine advances to the third receive state 308, and then returns to idle state 302. If a leading edge of a signal is detected to receive (IN_N=0), the state machine advances to the first receive state 304 and sets register and enable values as illustrated. When IN_N no longer is at logic one, the state machine advances to the second receive state 306, then to the third receive state 308, and then returns to idle state 302.

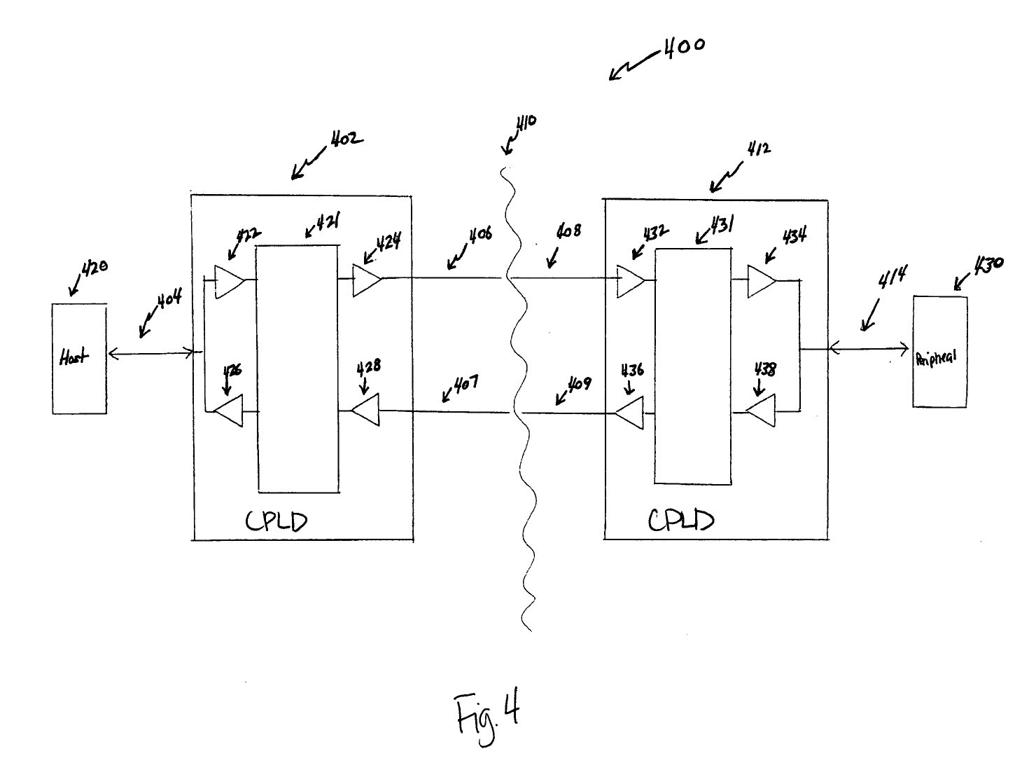

FIG. 4 illustrates a perspective view of a circuit 400 for isolating a USB link, according to one embodiment. A host 420 is shown with a single host USB line 404 connected to a host CPLD 402. A single left to right propagating signal is described as a representative example of the logic described above. If the host CPLD 402 detects the edge of an incoming signal on USB line 404 before detecting a signal on unidirectional host line 407, the host CPLD 402 will propagate the signal from left to right in FIG. 4, by turning on transistors 422 and 424 and turning off transistors 426 and 428. The signal will propagate through logic 421 to unidirectional output 406 to the isolation barrier 410. After the signal is isolated, peripheral CPLD 412 will detect the edge of an incoming signal on unidirectional peripheral line 408 before detecting anything on peripheral USB line 414. The peripheral CPLD 412 will propagate the signal from left to right in FIG. 4, by turning on transistors 432 and 434 and turning off transistors 436 (inhibiting unidirectional output line 409) and 438. The signal will propagate through logic 431 to peripheral USB line 414 to the peripheral 430. Those skilled in the art will appreciate that a signal propagating from right to left in FIG. 4 would be the reverse of the above description.

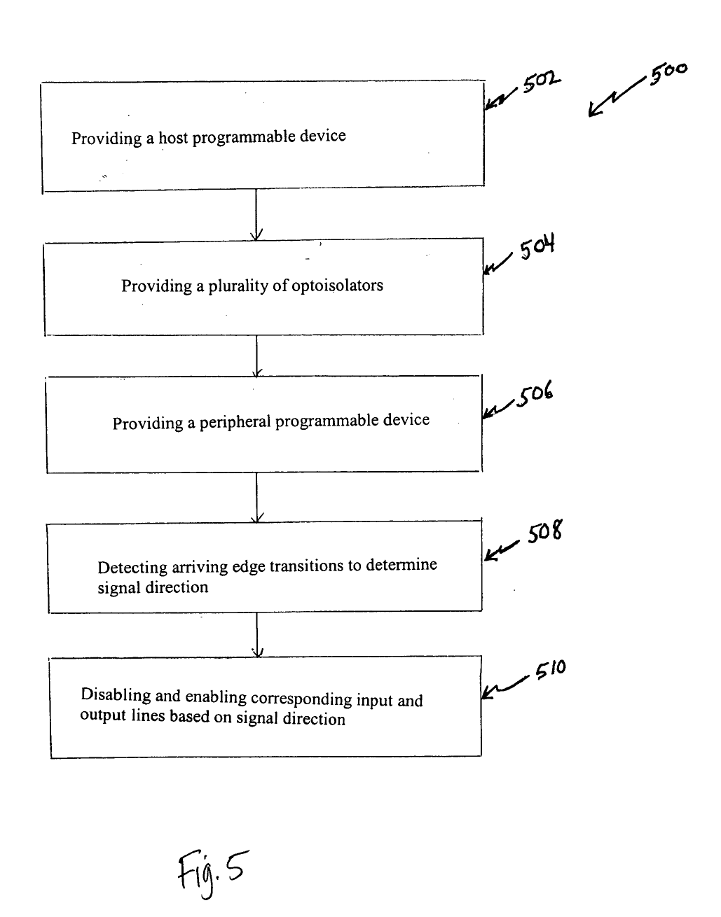

FIG. 5 illustrates a flow diagram of a method 500 for constructing an isolation barrier between a USB host and a USB peripheral, according to one embodiment. The method includes providing a host programmable device for selectively passing at least one host USB bidirectional line into a pair of host unidirectional lines, at 502. The method further includes providing a plurality of optoisolators connected to the host programmable device via the pair of host unidirectional lines, at 504. The method also includes providing a peripheral programmable device for selectively passing at least one pair of peripheral unidirectional lines into a peripheral USB bidirectional line, the peripheral programmable device connected to the plurality of optoisolators via the peripheral unidirectional lines, at 506. According to various embodiments, the method further includes detecting arriving edge transitions, using the host programmable device and the peripheral programmable device, to determine when a signal is arriving from a host or a peripheral, at 508. According to various embodiments, the method also includes disabling and enabling corresponding input and output lines based on the detected arriving edge transitions, using the host programmable device and the peripheral programmable device, to maintain unidirectional flow of the signal through the plurality of optoisolators, at 510.

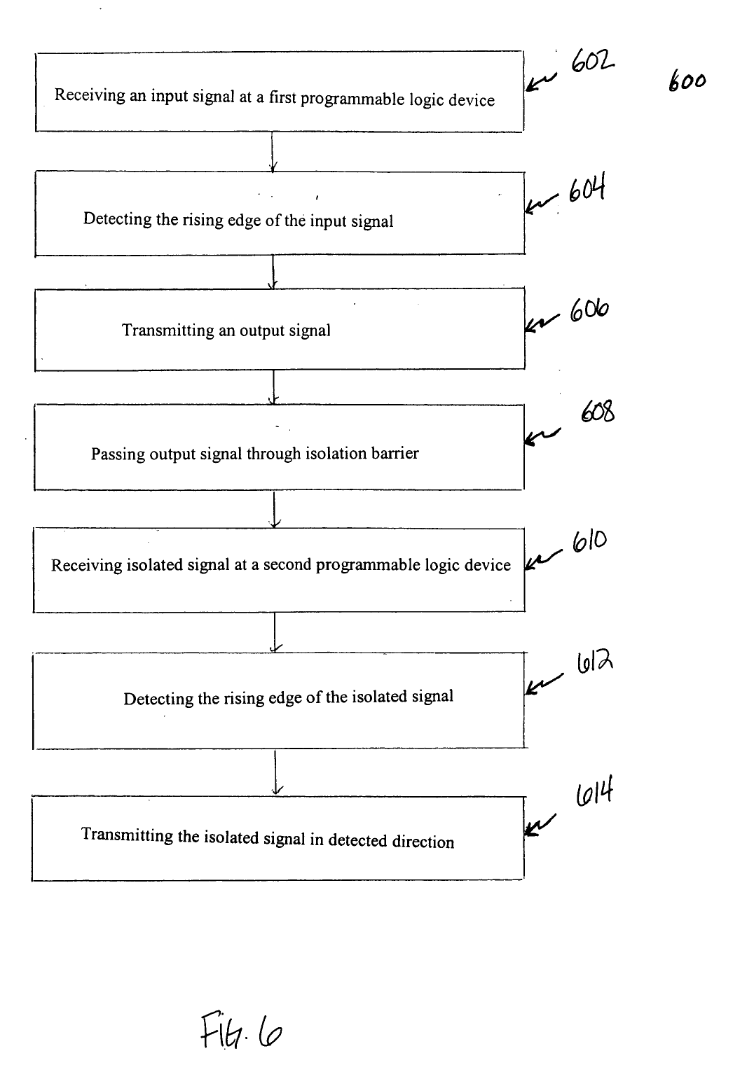

FIG. 6 illustrates a flow diagram of a method 600 for electrically isolating a host and peripheral, according to one embodiment. The method includes receiving an input signal at a first programmable logic device over a first bidirectional communication line, at 602, and detecting the rising edge of the input signal using the first programmable logic device to determine the direction of the input signal, at 604. According to various embodiments, the method also includes transmitting an output signal over a unidirectional output line in the direction of the input signal, at 606, and passing the output signal through an electrical isolation barrier to create an isolated signal, at 608. According to various embodiments, the method further includes receiving the isolated signal at a second programmable logic device over a unidirectional input line, at 610, detecting the rising edge of the isolated signal using the second programmable logic device to determine the direction of the isolated signal, at 612, and transmitting the isolated signal from the second programmable logic device in the detected direction over a second bidirectional communication line, at 614.

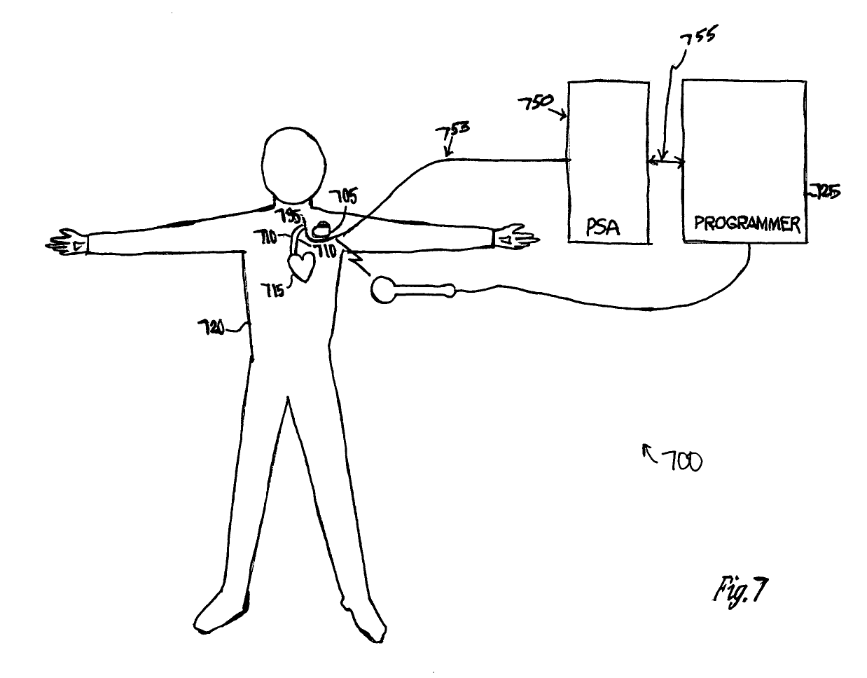

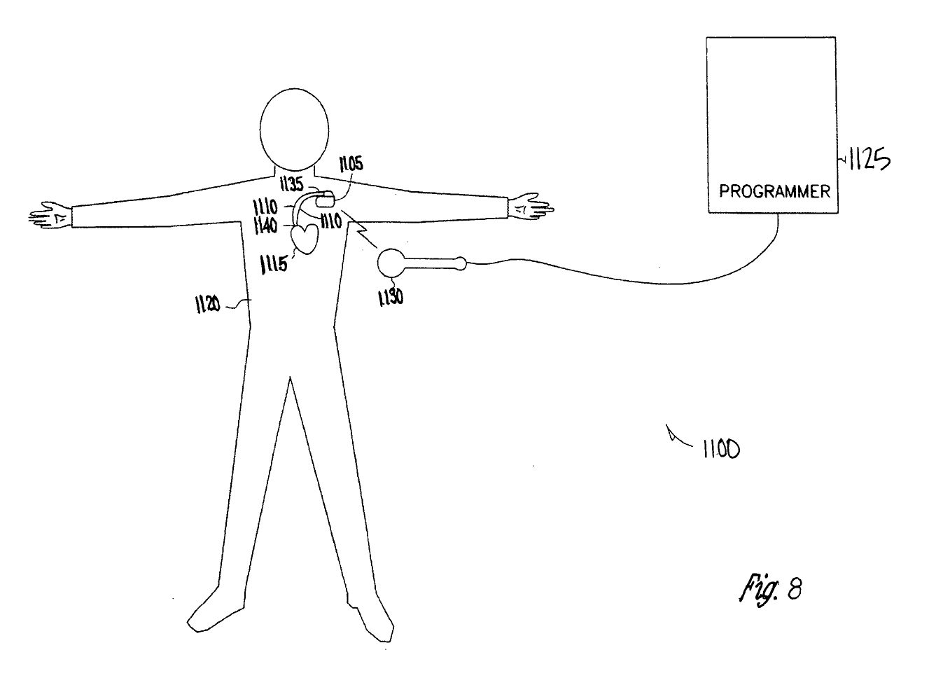

FIG. 7 illustrates a schematic diagram of portions of a cardiac rhythm management system 700 with a pacing system analyzer 750 and an environment in which they are used, according to one embodiment. An implantable medical device (IMD) 705, such as a cardioverter or cardiac rhythm management (CRM) device, is shown in communication with a device programmer 725. The programmer 725 is a micro-computer-based piece of equipment that is used to communicate with an IMD 705 to provide information during testing and follow-up exams. A programmer 725 is also used to adjust an IMD so that it senses and treats conditions appropriately. A more detailed description of a programmer/IMD system is discussed below with respect to FIG. 8. Programmer 725 is shown connected to Pacing System Analyzer (PSA) 750 via communication line 755. The PSA 750 is an external testing and measuring device used during IMD implantation to take various measurements from the leads to ensure they are correct. The PSA 750 has a direct connection 735 via line 753 to the leads 710 implanted in a heart 715 inside a human body 720. The PSA 750 is used during lead placement before the IMD 705 is attached to the leads 710. The PSA 750 is connected to the programmer 725 to download electrical characteristics of leads placed in the patient. In various embodiments, communication line 755 connecting the programmer 725 to PSA 750 is a USB link, requiring electrical isolation to protect the patient. The USB isolation system and method of the present disclosure is adapted to be used with USB link 755, with the programmer as host and the PSA as a peripheral.

FIG. 8 illustrates a schematic diagram of portions of a cardiac rhythm management system and an environment in which it is used, according to one embodiment. The diagram reflects the system after implantation, so the PSA of FIG. 7 is removed. System 1100 includes an implantable cardiac rhythm management (“CRM”) device 1105 coupled by an intravascular endocardial lead 1110, or other lead, to a heart 1115 of patient 1120. Catheter lead 1110 includes a proximal end 1135, which is coupled to device 1105, and a distal end 1140, which is coupled to one or more portions of heart 1115. CRM device 1105 contains electronic circuitry adapted to perform various tasks associated with cardiac rhythm management. CRM device 1105 includes processing circuits and memory for storing instructions for at least one therapy, a profile of programmable parameters associated with the at least one therapy, and measured patient cardiac data. The processing circuits perform cardiac rhythm management therapy based on the programmed parameters and, in some cases, measured patient cardiac data. Examples of CRM devices include the VITALITY, PRIZM, VENTAK®, PULSAR™, DISCOVERY™, MERIDAN™ and VIGOR™ families of implantable cardioverter defibrillators, automatic implantable cardioverter defibrillators, pacing systems and pacemakers, all by Cardiac Pacemaker, Inc. of St. Paul, Minn. System 1100 also includes an external medical device programmer 1125 providing wireless communication with device 1105 using a communication device 1130.

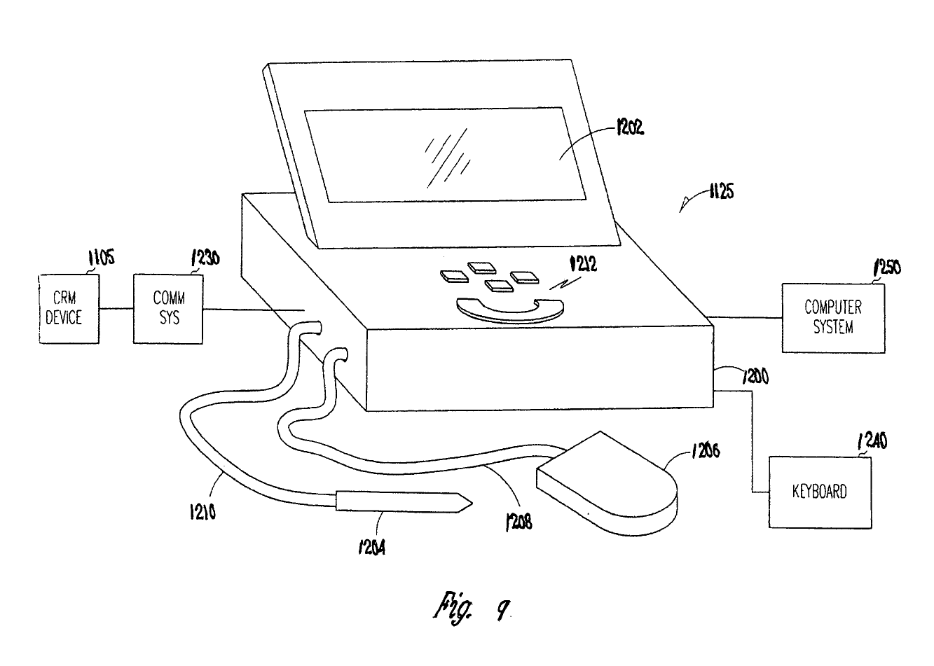

FIG. 9 illustrates a schematic diagram of a medical device programmer 1125, according to one embodiment. An example of a medical device programmer is the ZOOM™ programming system by Cardiac Pacemaker, Inc. of St. Paul, Minn. As previously mentioned, one embodiment of the medical device programmer 1125 for the implantable CRM device 1105 takes the form of an external controller. However, in an alternative embodiment, the medical device system is a completely external device such as an external cardioverting/defibrillator system as are known in the art, where the programmer unit is physically and electronically integrated into electronic control circuitry. In an embodiment, the electronic control circuitry of the external cardioverting/defibrillator system performs the same functions as the implantable CRM device 1105 described herein. In an embodiment, the electronic control circuitry of the external cardioverting/defibrillator system is the same as the electronic control circuitry of CRM device 1105. An example of this latter embodiment is for an external cardiac monitor and defibrillation unit, electrically connected to the heart by any combination of intracardiac catheters, epicardial electrodes and/or external cardiac electrodes.

Medical device programmer 1125 is designed to be positioned external of the human body 1120 for communicating with an implantable medical device, such as CRM device 1105 in FIG. 8, for example via wireless communication, RF telemetry or signal induction. Medical device programmer 1125 has programmer electronic circuitry, including a microprocessor and related circuitry, such as digital memory, which is coupled to an output unit, which is here shown as display screen 1202.

In one embodiment, the medical device programmer 1125 has an outer housing 1200 which is made of metal alloy, a thermal plastic or other suitable lightweight durable material. The display screen 1202 is disposed on the upper surface of housing 1200. The display screen 1202 folds down into a closed position when medical device programmer 1125 is not in use, thereby reducing the size of medical device programmer 1125 and protecting the display surface of display screen 1202 during transportation and storage. In another embodiment, the display screen 1202 is fixed in a single position, for example fixed directly on the housing. An embodiment of the present system includes providing the programmer 1125 with a video output connection to which a non-integral monitor can be connected. The interfaces as described herein may then be displayed on the non-integral monitors. In some embodiments, the external programmer additionally has a non-volatile storage, such as machine readable media, floppy disks, internal memory (e.g. BIOS, ROM) and a hard drive, and volatile storage, such as internal memory (e.g. RAM) disposed within the housing.

The medical device programmer 1125 is shown with the display screen 1202 positioned in one of a plurality of possible open positions such that a display on the display screen 1202 is visible to a user situated in front of medical device programmer 1125. In one embodiment, the display screen 1202 is of a CRT, LCD or electroluminescent type. The display screen 1202 is operatively coupled to the electronic circuitry disposed with the housing 1200 and is adapted to provide a visual display of graphics and/or data under control of the programmer electronic circuitry, e.g. processor and memory. The processor may be a commercially available processor available from Intel®, Cyrix®, AMD™ or other manufacturers, or may be a dedicated processor specifically designed for a medical device programmer. The processor runs either a commercially available operating systems or specially designed operating systems dedicated to medical device programmers. The memory in the programmer stores software for programming parameters into a profile of parameters for a therapy. The memory further stores programmable parameters that are used by the software to control operation of the CRM device.

Medical device programmer 1125 further includes a user input device coupled to the electronic circuitry. In one embodiment, the user input device is the screen 1202, which is provided with touch-sensitive capability, such that a user can interact with the programmer electronic circuitry by touching the display area on screen 1202 with a finger (not shown), a stylus 1204, or other pointing device. In one embodiment, the touch-sensitive display screen is the primary input for the medical device programmer 1125. The medical device programmer 1125 further includes a programming head 1206, which is place over a patient's body near the implant site of an implanted device, such as CRM device 1105, in order to establish a communication link between CRM device 1105 and programmer 1125. The communication link between CRM device 1105 and programmer 1125 allows the electronic circuitry of programmer 1125 to be coupled to the electronic control circuitry of the CRM device 1105. The programming head 1206 is coupled to the electronic circuitry of medical device programmer 1125 by a cable 1208 and includes a receiver circuit for receiving signals from a transmitter circuit of CRM device 1105. In another embodiment, a communication system 1230 is intermediate programmer 1125 and the CRM device 1105, for example the telephone system or a computer network such as a LAN, WAN, or global computer network (e.g. internet). Consequently, the programmer 1125 remotely monitors and receives data from the CRM device 1105. In one embodiment, communication system 1230 establishes a type of client/server relationship between the CRM device 1105 and the programmer 1125.

In one embodiment of the system, stylus 1204 used to interact with the touch-sensitive display screen 1202 is coupled to the programmer electronic circuitry within the housing 1200 by a cable 1210. In another embodiment of the system, only a touch sensitive screen 1202 is provided which is activated by a user's finger touching the screen. Alternatively, medical device programmer 1125 may be equipped with a conventional computer “mouse”-type pointing device, rather than a stylus or a touch sensitive screen which is actuatable by a user's finger. In the absence of either a stylus, touch-sensitive screen or a mouse, on-screen cursor control for enabling user interaction with medical device programmer 1125 may be facilitated through cursor control keys 1212 (arrow keys or the like) disposed on medical device programmer 1125. Another embodiment in lieu of the touch sensitive screen, mouse, or stylus, is providing a serial connection on the programmer 1125 for using a keyboard 1240 as the input device.

Programmer 1125 is also connectable to a computer system 1250, for example direct connection through parallel ports or universal bus, modems over telephone connections, LAN, WAN, or other global computer network connections. While the description herein focuses on the programmer 1125 providing the navigation and guidance for setting up profiles of parameters for CRM device 1105, it will be understood that it is within the scope of the present system to perform the navigation and guidance for programming parameter profiles in computer system 1250 separate from programmer 1125. Thereafter, the profiles are downloaded to the programmer 1125, for example over connection or by downloading the profile to a portable data storage medium and loading the profile from the medium to the programmer 1125 for subsequent programming of CRM device 1105.

This disclosure includes several processes, circuit diagrams, and structures. The present invention is not limited to a particular process order or logical arrangement. Although specific embodiments have been illustrated and described herein, it will be appreciated by those of ordinary skill in the art that any arrangement which is calculated to achieve the same purpose may be substituted for the specific embodiment shown. This application is intended to cover adaptations or variations, and includes other applications in which the above structures and fabrication methods are used. It is to be understood that the above description is intended to be illustrative, and not restrictive. Combinations of the above embodiments, and other embodiments, will be apparent to those of skill in the art upon reviewing the above description. The scope of the present invention should be determined with reference to the appended claims, along with legal equivalents to which such claims are entitled.

1. An apparatus, comprising:
first logic including a first bidirectional universal serial bus (USB) connection, the first logic to receive a pair of incoming complementary USB signals from the first USB connection and produce a first output signal and a second output signal and for receiving a first input signal and a second input signal and produce a pair of outgoing complementary USB signals at the first USB connection;
second logic including a second bidirectional universal serial bus (USB) connection, the second logic to receive a pair of incoming complementary USB signals from the second bidirectional USB connection and produce a third output signal and a fourth output signal and for receiving a third input signal and a fourth input signal and produce a pair of outgoing complementary USB signals at the second USB connection; and
a bank of four optoisolators to isolate the first logic from the second logic, such that the first output signal is optically isolated to produce the third input signal, the second output signal is optically isolated to produce the fourth input signal, the third output signal is optically isolated to produce the first input signal, and the fourth output signal is optically isolated to produce the second input signal;
wherein the first logic and the second logic detect arriving edge transitions to determine whether a signal is arriving from a host or a peripheral, and disable and enable corresponding input and output lines to maintain unidirectional flow of the signal through the bank of optoisolators.

2. The apparatus of claim 1, wherein the host includes a medical device programmer.

3. The apparatus of claim 1, wherein the peripheral includes a pacing system analyzer (PSA).

4. The apparatus of claim 1, wherein the host includes a personal computer.

5. The apparatus of claim 1, wherein the system provides no more than 80 nsec of delay to propagate the signal.

6. A system, comprising:
a first programmable logic device for selectively passing two host USB lines into four host unidirectional lines;
four optoisolators connected to the four host unidirectional lines;
a second programmable logic device for selectively passing four peripheral unidirectional lines into two peripheral USB lines, the second programmable logic device connected to the four optoisolators via the four peripheral unidirectional lines;
wherein the first and second programmable logic devices detect arriving edge transitions to determine the direction of the signal, and enable outputs in the directional of the signal and disable outputs in the opposite direction of the signal to maintain unidirectional flow of the signal through the optoisolators.

7. The system of claim 6, further comprising a host device connected to the first programmable logic device via the two host USB lines.

8. The system of claim 7, wherein the host device includes a medical device programmer.

9. The system of claim 6, further comprising a peripheral device connected to the second programmable logic device via the two peripheral USB lines.

10. The system of claim 9, wherein the peripheral device includes a pacing system analyzer (PSA).

11. A method, comprising:
receiving an input signal at a first programmable logic device over a first bidirectional communication line;
detecting the rising edge of the input signal using the first programmable logic device to determine the direction of the input signal;
transmitting an output signal over a unidirectional output line in the direction of the input signal;
passing the output signal through an electrical isolation barrier to create an isolated signal;
receiving the isolated signal at a second programmable logic device over a unidirectional input line;
detecting the rising edge of the isolated signal using the second programmable logic device to determine the direction of the isolated signal; and
transmitting the isolated signal from the second programmable logic device in the detected direction over a second bidirectional communication line.

12. The method of claim 11, wherein passing the output signal through an electrical isolation barrier includes passing the output signal through an optoisolator.

13. The method of claim 11, wherein passing the output signal through an electrical isolation barrier includes passing the output signal through a magnetic isolator.

14. The method of claim 11, wherein passing the output signal through an electrical isolation barrier includes passing the output signal through a laser isolator.

15. The method of claim 11, wherein receiving an input signal at a first programmable logic device over a first bidirectional communication line includes receiving an input signal over a USB communication line.

16. The method of claim 11, wherein transmitting the isolated signal from the second programmable logic device over a second bidirectional communication line includes transmitting the isolated signal over a USB communication line.

17. A method for constructing an isolation barrier between a USB host and a USB peripheral, comprising:
providing a host programmable device for selectively passing at least one host USB bidirectional line into a pair of host unidirectional lines;
providing a plurality of optoisolators connected to the host programmable device via the pair of host unidirectional lines;
providing a peripheral programmable device for selectively passing at least one pair of peripheral unidirectional lines into a peripheral USB bidirectional line, the peripheral programmable device connected to the plurality of optoisolators via the peripheral unidirectional lines;
detecting arriving edge transitions, using the host programmable device and the peripheral programmable device, to determine when a signal is arriving from a host or a peripheral; and
disabling and enabling corresponding input and output lines based on the detected arriving edge transitions, using the host programmable device and the peripheral programmable device, to maintain unidirectional flow of the signal through the plurality of optoisolators.

18. The method of claim 17, wherein providing a host programmable device includes providing a complex programmable logic device (CPLD).

19. The method of claim 17, wherein providing a peripheral programmable device includes providing a complex programmable logic device (CPLD).

20. The method of claim 17, wherein providing a plurality of optoisolators includes providing at least one optoisolator for each host unidirectional line.
